(19) United States
(12) Patent Application Publication
(10) Pub. No.: US 2009/0117815 A1
(43) Pub. Date: May 7, 2009

(54) BLOCK TOY AND PROCESS FOR PRODUCING THE SAME

(76) Inventor: Hideyuki Hiraide, Tokyo (JP)

Correspondence Address: RISSMAN JOBSE HENDRICKS & OLIVERIO, LLP, 100 Cambridge Street, Suite 2101, BOSTON, MA, 02114, US

(21) Appl. No.: 12/263,215

(22) Filed: Oct. 31, 2008

Related U.S. Application Data
(63) Continuation of application No. PCT/JP2007/000946, filed on Aug. 31, 2007.

(30) Foreign Application Priority Data
Sep. 15, 2006 (JP) 2006-251588

(51) Int. Cl. A63H 33/08; B28B 1/00

(52) U.S. Cl. 446/124; 264/299

(57) ABSTRACT

A block toy that ensures easy die forming and rapid die forming, attaining reduction of production cost and that permits junction in three-dimensional directions; and a process for producing the same. The block toy is one consisting of hexahedron blocks formed so as to allow mutual engagement and junction, wherein the blocks have facial parts each of which is provided with multiple projecting portions and recessed portions, and wherein the recessed portions are formed in areas adjacent in upward, downward and lateral directions to the projecting portions, and wherein the recessed portions are sized so as to be capable of accommodating the projecting portions, and wherein the projecting portions and recessed portions are formed through arranging in mutually antiphase relationship in two faces opposite to each other and die forming.

### FIELD OF THE INVENTION

The present invention relates to a block toy and a method for producing the same, and in particular to a block toy that can have other block toys connected thereto in succession in three dimensional directions to form various shapes and a method for producing the same.

### BACKGROUND

Various block toys have been produced and sold. These conventional block toys have been constructed in the following manner: for example, the construction body of a block toy made of synthetic resin in a rectangular prism has plural projecting portions formed only on the upper face portion thereof and can have other construction bodies connected thereto in succession only in the direction of the face having these projecting portions formed thereon, thereby forming various shapes such as a column and a bridge.

In the conventional block toy like this, the direction in which the block toys are connected in succession is limited only to the direction a face having the projecting portions formed thereon. Thus, to solve this problem, there has been proposed a block toy formed in such a way as to have other block toys connected thereto in succession in three dimensional directions (patent documents 1 to 4).

Patent document 1: JP-B-50-34980
Patent document 2: JP-UM-B-49-39593
Patent document 3: JP-UM-A-54-94597
Patent document 4: JP-A-2001-120850

### SUMMARY OF THE INVENTION

However, in all of these conventional block toys, the projecting portions formed on the construction body of the block toy formed nearly in a cube are formed in plural rows in the width direction of the construction body.

Thus, in the conventional block toy like this, when a block toy construction body is produced by die forming, because the block toy construction body has the projecting portions of plural steps formed on each faces thereof, the block toy construction body cannot be produced by one die-forming process. Therefore, the conventional block toy has raised the problem of requiring a very complex die-forming process and increasing production cost as a result.

Moreover, when the block toy is produced by a process other than the die-forming process, many projecting portions need to be planted in the block toy construction body formed in a cube, which makes a production work very troublesome. Further, when the block toy is produced by the other method than has been described above, the block toy needs to be produced by fixing the respective face construction parts of the block toy construction body, which have many projecting portions formed separately, to the respective faces of the block toy construction body.

Thus, even if the block toy is produced by anyone of the above-mentioned methods, when a block toy capable of having other block toys connected thereto in succession in three dimensional directions is produced, there is presented the problem that the production of the block toy requires many processes and hence increases production cost.

Thus, the technical problem of the present invention is to provide a block toy that can be produced easily and quickly by die forming and that can reduce production cost and that can have other block toys connected thereto in succession in three dimensional directions a method for producing the same.

To solve the above-mentioned problems, the invention is a block toy that is formed of a hexahedron and which can be engaged with and connected to each other, and is characterized in that each face portion has a plurality of projecting portions and a plurality of recessed portions, wherein the recessed portions are formed at portions adjacent in an upward direction, in a downward direction, and in a left and right direction to the projecting portions and are formed in sizes capable of receiving the projecting portions, and in that the block toy is formed by die forming.

Thus, according to one embodiment of the invention, by bonding a plurality of block toys in such a way that the projecting portions and the recessed portions thereof are engaged with each other, the plurality of block toys can be continuously connected to each other in the respective directions of six faces.

According to one embodiment, the invention is characterized in that two pairs of side opposite faces have the projecting portions of upper and lower two steps, in that the projecting portion of the upper step is formed by an upper die and the projecting portion of the lower step is formed by a lower die, and in that the block toy is produced by die forming so as to be formed by separating the upper die and the lower die between the projecting portion of the upper step and the projecting portion of the lower step.

Thus, according to one embodiment the two pairs of side opposite faces to form the side faces of the block toy are produced by means of the upper die and the lower die having the projecting portions of upper and lower two steps. Thus, when the block toy like this is produced by die forming, the upper projecting portions of the projecting portions of upper and lower two steps are formed by the upper die, and the lower projecting portions are formed by the lower die, and then the upper die and the lower die are separated from each other between the projecting portions of the upper and lower two steps. In this manner, the block toy can be produced by one die-forming process.

According to another embodiment, the projecting portions of the upper and lower two steps include one pair of projecting portions formed opposite to a side face direction via a recessed portion and another projecting portion formed adjacently in an up and down direction to the recessed portion.

According to another embodiment, the block toy is a block toy having projecting portions of three steps on two pairs of side opposite faces, and in that the block toy is formed by bonding two block toy construction bodies produced by die forming using an upper die and a lower die.

According to another embodiment, of the two block toy construction bodies, one block toy construction body has two pairs of side opposite faces having projecting portions of two steps, and in that another block toy construction body has two pairs of side opposite faces having projecting portions of one step.

In the case of the block toy having the projecting portions of three steps, for example, a face having a recessed portion formed thereon is formed between such four projecting portions of upper, lower, right, and left projecting portions that construct the projecting portions of three steps. Thus, unlike the case of the block toy having the projecting portions of two steps, the following die forming process used for producing the block toy having the projecting portions of upper and lower two steps cannot be performed: that is, the die forming process cannot be performed in which constituent portions having projecting portions forming the respective steps are formed by an upper die and an lower die and in which the upper die and the lower die are then separated upward and downward from each other, thereby being stripped.

However, according to one embodiment, for example, by preparing one block toy construction body having projecting portions of two steps in an up and down direction and another block toy construction body having projecting portions of one step by the same die forming process as described above and by bonding these block toy construction bodies to each other by means of an adhesive or the like, a block toy having the projecting portions of three steps on side opposite faces can be formed.

Thus, according to the embodiment just described having three steps, by bonding two block toy construction bodies, a block toy having the projecting portions of three steps in the up and down direction can be formed.

According to another embodiment, in one of one pair of side opposite faces, the projecting portions of three steps in the up and down direction has: two recessed portions connected to each other in the up and down direction; a pair of projecting portions arranged respectively on both sides of the two recessed portions; and a projection portion arranged adjacently in the up and down direction to the recessed portion, and in that in another of the one pair of side opposite faces, the projecting portions of three steps in the up and down direction have: two projecting portions connected to each other in the up and down direction; a recessed portion arranged adjacently in the up and down direction of the two projecting portions; and a projecting portion arranged adjacently in a left and right direction to the recessed portion.

According to another embodiment each of the two block toy construction bodies has two pairs of side opposite faces having the projecting portion of a first step and a half portion in the up and down direction of the projecting portion of a second step.

In the case of forming a block toy of upper and lower three steps, in addition, the block toy can be also produced, for example, by bonding two block toy construction bodies, each of which has two pairs of side opposite faces having the projecting portion of a first step and a half portion in the up and down direction of the projecting portion of a second step, in the up and down direction.

Thus, according to this embodiment, it is possible to provide a block toy having more flexibility in production.

According to another embodiment, the projecting portions of three steps in the up and down direction include: a pair of projecting portions formed opposite to a side face direction via a recessed portion in a middle step portion; and another pair of projecting portions that are formed adjacently in the up and down direction to the recessed portion and which are opposite to each other.

According to another embodiment, the block toy is a block toy having projecting portions of four steps in an up and down direction on two pairs of side opposite faces and is formed by bonding two block toy construction bodies produced by die forming using an upper die and a lower die.

According to another embodiment, each of the two block toy construction bodies has one pair of side opposite faces having projecting portions of two steps.

Thus, even if a block toy having the projecting portions of upper and lower four steps on the side opposite faces, the block toy can be constructed by overlaying block toy construction bodies, each of which has the projecting portions of upper and lower two steps on the side opposite faces, in, the up and down direction and by bonding the block toy construction bodies to each other with an adhesive or the like.

In this embodiment, only the block toy having the projecting portions of four steps in the up and down direction is claimed, but by bonding plural block toy construction bodies by the same method, it is possible to produce a block toy having the projecting portions of five or more steps in the up and down direction.

According to another embodiment, the projecting portions of four steps in the up and down direction include: one pair of projecting portions formed opposite to, a side face direction via a depressed portion; a projecting portion formed adjacently in the up and down direction to the recessed portion; one pair of projecting portions formed opposite to the side face direction via a recessed portion formed adjacently in the up and down direction to the projecting portion; and a projecting portion formed adjacently in the up and down direction to the recessed portion.

Thus, to surely insert and engage the projecting portions of a certain block toy into and with the recessed portions of another block toy, specified gap portions are formed between the projecting portions to absorb a production error, whereby the projecting portions of the other block toy can be easily inserted into and engaged with the recessed portions.

According to another embodiment, each of the projecting portions is formed in a cube or a rectangular prism.

According to another embodiment, each of the projecting portion and the recessed portion is formed in a cube of same dimensions.

According to another embodiment, each of the projecting portion and the recessed portion is formed in a cube in which all of length, width, and height are of the same dimension.

Therefore, when a certain block toy is joined and connected to another block toy, the projecting portions and the recessed portions of the plural block toys can be completely fitted in each other.

According to another embodiment, a gap portion is formed between the projecting portions formed adjacently to each other.

Because each of the projecting portions adjacent to each other is formed in a cube or a rectangular prism, when the respective projecting portions are formed by die forming in a state where gaps are not formed between the respective projecting portions, even if the respective projecting portions of one block toy are inserted into the respective recessed portions of the other block toy when the block toys are connected to each other, there is a possibility that the insertion will be very difficult because plays are not formed between the recessed portions and the projecting portions.

Moreover, because the block toy is formed by die forming, in many cases, the block toy formed by the die forming has a specified production error for each portions and hence even if the block toy is produced on the basis of the same specified dimensions, there also happens a case in which the projecting portions of one block toy cannot be inserted into the recessed portions of the other block to.

Moreover, in this embodiment, the projecting portion is formed in the shape of a polygonal prism. In another embodiment, the projecting portion is formed in the shape of a triangular prism.

In another embodiment, the projecting portion is formed in the shape of a pentagonal prism. Moreover the projecting portion is formed in the shape of a hexagonal prism. Further, in another embodiment the projecting portion is formed in the shape of an octagonal prism.

In another embodiment, the projecting portion is formed in the shape of a circular cylinder.

Thus, when the block toys are connected to each other, the respective recessed portions of one block toy are brought into line contact along an axial direction with the respective projecting portions of the other block toy, and hence the respective recessed portions can be easily inserted into the respective projecting portions.

Moreover, according to one embodiment, the projecting portions formed on the two pairs of side opposite faces are formed in the shape of a prism having an upper portion of a cross section shaped like a nearly circular arc projecting upward and in a shape of a prism having a lower portion of a cross section shaped like a nearly circular arc projecting downward.

Thus, when the block toys are connected to each other in the side face direction, gaps are formed between the recessed portions and the projecting portions which are bonded to each other by the upper portions or the lower portions each having the cross section shaped like a nearly circular arc, so that the projecting portions can be easily inserted into the recessed portions.

Moreover, according to another embodiment, the projecting portions are formed in upper and lower two steps, in that an upper projecting portion is formed in the shape of a prism having an upper portion of a cross section shaped like a nearly circular arc projecting upward, and in that a lower projecting portion is formed in the shape of a prism having a lower portion of a cross section shaped like a nearly circular arc projecting downward.

Thus, according to one embodiment, the two pairs of side opposite faces to form the side faces of the block toy produced by means of the upper die and the lower die have the projecting portions of upper and lower two steps. Thus, when the block toy like this is produced by die forming, the upper projecting portions of the projecting portions of upper and lower two steps are formed by the upper die, and the lower projecting portion are formed by the lower die, and then the upper die and the lower die are separated from each other between the projecting portions of the upper and lower two steps. In this manner, the block toy can be produced by one die-forming process.

Moreover, according to another embodiment, the projecting portions are formed in upper and lower three steps, in that an upper projecting portion is formed in the shape of a prism having an upper portion of a cross section shaped like a nearly circular arc projecting upward; in that a lower projecting portion is formed in the shape of a prism having a lower portion of a cross section shaped like a nearly circular arc projecting downward; and in that a middle step is formed in a rectangular prism.

Further, according to another embodiment, the projecting portions are formed in upper and lower four steps, in that an upper projecting portion is formed in the shape of a prism having an upper portion of a cross section shaped like a nearly circular arc projecting upward; in that a lower projecting portion is formed in the shape of a prism having a lower portion of a cross section shaped like a nearly circular arc projecting downward; and in that each of two rows of middle steps is formed in a rectangular prism.

Thus, because gaps are formed between the recessed portions and the projecting portions, the projecting portions can be easily inserted into the recessed portions, and because each of the middle two rows is formed in the rectangular prism, a beautiful design in terms of visual sense can be produced.

Moreover, according to another embodiment, each of the projecting portions formed on an upper face portion and a lower face portion of the block toy is formed in the shape of a circular cylinder.

Thus, when the block toys are connected to each other in the up and down direction, the recessed portions are brought into line contact along the axial direction with the projecting portions, and hence the projecting portions can be easily inserted into the recessed portions.

According to another embodiment, a circular cylindrical hollow is formed in the up and down direction in each of the recessed portions formed on an upper face portion and a lower face portion of the block toy and in each of opposite faces of faces, each of which has across section shaped like a nearly circular arc, of the projecting portions formed on the two pairs of side opposite faces.

Thus, the thickness of a raw material constructing the block toy can be made uniform, so that a phenomenon called “shrinkage” that the side faces of the block toy are shrunk when the dies are stripped in the forming of the block toy by die forming is less caused.

According to another embodiment, a through hole is formed in the up and down direction in each of the projecting portions formed on an upper face portion and a lower face portion of the block toy.

Thus, because the holes or through holes are formed, the projecting portions and the recessed portions of the block toy can be increased in elasticity, and hence even when a little production error is caused by die forming, the production error can be absorbed and hence the block toys can be joined and connected to each other in succession.

According to another embodiment, the block toy is formed of synthetic resin. The synthetic resin may be ABS resin, styrene resin, polyethylene resin, and polypropylene resin.

According to one embodiment, a method is provided for producing a block toy, which is a exahedron and has projecting portions of upper and lower two steps on side faces, by an upper die and a lower die, the method being characterized in that two pairs of side opposite faces have projecting portions of upper and lower two steps, in that the projecting portion of the upper step is produced by the upper die and the projecting portion of the lower step is produced by the lower die, and in that the block toy is produced by die forming in such a way that the upper die and the lower die are separated from each other between the projecting portion of the upper step and the projecting portion of the lower step.

According to another embodiment, the block toy is produced so as to be engaged with and connected to each other, in that each of face portions has a plurality of projecting portions and a plurality of recessed portions, and in that the recessed portions are formed at portions adjacent in an upward direction, in a downward direction, and in a left and right direction to the projecting portions and are formed in sizes capable of receiving the projecting portions.

According to another embodiment, the block toy having the projecting portions of three or more steps in an up and down direction on side faces is produced by bonding a block toy construction body having the projecting portions of upper and lower two steps on the side faces to a block toy construction body having the projecting portions of upper and lower one step or more on the side faces.

Thus, according to various embodiments of the invention, it is possible to provide a block toy that can be easily formed by die forming, can reduce production cost, and can have other block toys connected thereto in three dimensional directions.

The block toy may be formed by a die forming process such that: the upper projecting portions of the projecting portions of upper and lower two steps are formed by means of the upper die; the lower projecting portions are formed by means of the lower die; and the upper die and the lower die are separated in the up and down direction so as to form a parting line between the projecting portions of upper and lower two steps is performed. With this, the block toy can be formed by one die-forming process.

As a result, in it is possible to provide the block toy that can be produced more easily and quickly by die forming.

According to one embodiment, the block toy having the projecting portions of three steps on one pair of side opposite faces is produced by bonding the two block toy construction bodies produced by die forming using the upper die and the lower die. Not only the block toy having the projecting portions of two steps in the up and down direction but also the block toy having the projecting portions of three steps in the up and down direction can be easily produced.

According to one embodiment, when a block toy of upper and lower three steps is formed, the block toy can be also produced, for example, by bonding toy block construction bodies, each of which has two pairs of side opposite faces each having the projecting portion of a first step and a half portion of the width direction of the projecting portion of a second step, in the up and down direction.

Thus, it is possible to produce the block toy having the projecting portions of upper and lower three steps of different constructions. As a result, it is possible to increase flexibility in the production of the block toy having the projecting portions of upper and lower three steps.

It is possible to produce the block toy having the projecting portions of four steps in the up and down direction formed on two pairs of side opposite faces.

Thus, it is possible to increase the variety of kinds of the block toys that can be connected to each other in the directions of six faces and to provide the block toy meeting various needs.

According to one embodiment, the projecting portion is formed in the rectangular prism, so that it is possible to provide a block toy that can be surely joined to other block toy when joined to the other block toy.

According to another embodiment, the projecting portions and the recessed portions are formed in cubes of the same dimensions, so that when one block toy is joined to the other block toy, the projecting portions and the recessed portions of the plural block toys can be completely fitted in each other.

As a result, it is possible to provide a block toy that can be more surely joined to other block toy in the case of joining the block toys.

According to one embodiment, the gap portions are formed between the projecting portions adjacent to each other and hence the projecting portions and the recessed portions can be easily engaged with each other. Thus, it is possible to provide a block toy capable of effectively absorbing a little production error which might be caused by die forming and hence of being connected to the other block toy.

Moreover, according to various embodiments, it is possible to provide various kinds of block toys that have various shapes of projecting portions and that can improve an external appearance quality and can respond to a variety of needs of products.

Further, according to one embodiment, the projecting portion is formed in the shape of a circular cylinder, so that large gaps are formed between the respective portions and hence when the block toys are bonded to each other, the projecting portions can be easily engaged with the recessed portions. Thus, it is possible to provide a block toy that can effectively absorb a little production error, which might be caused by die forming, and that can be connected to other block toy.

According to one embodiment, the projecting portions formed on the two pairs of side opposite faces are formed in the shape of a prism having an upper portion of a cross section shaped like a nearly circular arc projecting upward and in the shape of a prism having a lower portion of a cross section shaped like a nearly circular arc projecting downward, so that when the block toys are joined to each other, gaps are formed by the upper portions and the lower portions each having the cross section shaped like the nearly circular arc, whereby the production error caused when the block toy is formed by die forming can be absorbed. As a result, it is possible to provide a block toy that can have the projecting portions of the other block toys easily inserted into the recessed portions thereof and that can be easily handled.

Moreover, according to one embodiment, the upper projecting portions are formed by the upper die, and the lower projecting portions are formed by the lower die, and then the upper die and the lower die are separated from each other in the up and down direction in such a way that a parting line is formed between the projecting portions of the upper and lower two steps. In this manner, the block toy can be produced by one die-forming process.

At this time, the projecting portions on the side opposite faces are formed in the shape of a prism having an upper portion of a cross section shaped like a nearly circular arc projecting upward and in the shape of a prism having a lower portion of a cross section shaped like a nearly circular arc projecting downward, so that an acute shape is not produced on the inner faces of the dies for the die forming, which can prevent the dies from being damaged by sliding contact in the up and down direction.

According to the one embodiment, the projecting portions and the recessed portions are easily engaged with each other. Thus, it is possible to provide a block toy that can effectively absorb a little production error, which might be caused by the die forming, and that can be connected to the other block toys in succession.

According to one embodiment, a circular cylindrical hollow is formed in the up and down direction in each of the recessed portions formed on the upper face portion and the lower face portion of the block toy and of opposite faces of faces, each of which has a cross section shaped like a nearly circular arc, of the projecting portions formed on the two pairs of side opposite faces. Thus, the thickness of a raw material constructing the block toy can be made uniform, so that a phenomenon called “shrinkage” that the side faces of the block toy are shrunk when the dies are stripped in the forming of the block toy by die forming is less caused. Thus, it is possible to reduce the defective rate of the products.

According to one embodiment, a through hole is formed in the up and down direction in each of the projecting portions formed on the upper face portion and the lower face portion of the block toy, so that the projecting portions can be increased in elasticity. Thus, it is possible to provide a block toy that can effectively absorb a little production error, which might be caused by the die forming, and that can be connected to the other block toys in succession.

According to one embodiment, the block toys are constructed of specified synthetic resins, respectively. Thus, it is possible to provide a block toy that can be easily produced by die forming and that is light in weight and that can be easily handled.

According to various embodiments, there is provided the method for producing a block toy that can be easily produced by die forming and that can reduce production cost and that can have other block toys connected thereto in succession in the three dimensional directions.

According to one embodiment, the block toy having the projecting portions of three or more steps in the up and down direction can be easily produced. Thus, there is provided the effect of providing a block toy of various modes meeting the needs of products.

### BRIEF DESCRIPTION OF THE DRAWINGS

FIG. 1 is a perspective view to show an embodiment of a block toy according to the present invention, that is, a basic shape.

FIG. 2 is a plan view to show the embodiment of the block toy according to the present invention, that is, the basic shape.

FIG. 3 is a bottom view to show the embodiment of the block toy according to the present invention, that is, the basic shape.

FIG. 4 is an illustration to show the embodiment of the block toy according to the present invention and a state in which two basic shapes are bonded to each other on side opposite faces.

FIG. 5 is a perspective view to show the embodiment of the block toy according to the present invention by an imaginary line, that is, a state in which the block toys are bonded to each other in six face directions by the use of the basic shape.

FIG. 6 is a perspective view to show the embodiment of the block toy according to the present invention, that is, an embodiment when projecting portions and recessed portions on the side faces opposite to each other are formed in the same phase.

FIG. 7 is a perspective view to show an embodiment of the block toy according to the present invention, that is, another embodiment of the basic shape.

FIG. 8 is a perspective view to show another embodiment of the block toy according to the present invention, that is, a mode having projecting portions of upper and lower three steps on side opposite faces.

FIG. 9 is a perspective view to show the another embodiment of the block toy according to the present invention, that is, a mode having projecting portions of upper and lower three steps on side opposite faces, or an exploded view, in perspective, of a case in which the block toy is produced by bonding two block toy construction bodies to each other in the up and down direction.

FIG. 10 is a perspective view to show an embodiment of the block toy according to the present invention, that is, another embodiment of a mode having projecting portions of upper and lower three steps on side opposite faces.

FIG. 11 is a perspective view to show an embodiment of the block toy according to the present invention, that is, another embodiment of a mode having projecting portions of upper and lower three steps on side opposite faces, or a state in which the block toy is produced by bonding two block toy construction bodies to each other in the up and down direction.

FIG. 12 is a perspective view to show another embodiment of the block toy according to the present invention, that is, an embodiment of a mode having projecting portions of upper and lower four steps on side opposite faces.

FIG. 13 is a perspective view to show an embodiment of the block toy according to the present invention, that is, a mode having projecting portions of upper and lower four steps on side opposite faces, or an exploded view, in perspective, of a state in which the block toy is produced by bonding upper and lower two block toy construction bodies to each other.

FIG. 14 is a perspective view to show an embodiment of the block toy according to the present invention, that is, another embodiment of the basic shape.

FIG. 15 is a perspective view to show an embodiment of the block toy according to the present invention, that is, still another embodiment of the basic shape.

FIG. 16 is a perspective view to show an embodiment of the block toy according to the present invention, that is, still another embodiment of the basic shape.

FIG. 17 is a perspective view to show an embodiment of the block toy according to the present invention, that is, still another embodiment of the basic shape.

FIG. 18 is a perspective view to show an embodiment of the block toy according to the present invention, that is, still another embodiment of the basic shape.

FIG. 19 is a perspective view to show an embodiment of the block toy according to the present invention, that is, still another embodiment of the basic shape.

FIG. 20 is a perspective view to show an embodiment of the block toy according to the present invention, that is, still another embodiment of the basic shape.

FIG. 21 is a plan view to show the embodiment of the block toy according to the present invention, that is, the block toy shown in FIG. 20.

FIG. 22 is a bottom view to show the embodiment of the block toy according to the present invention, that is, the block toy shown in FIG. 20.

FIG. 23 is a section view to show die cross sections of an upper die and a lower die when the block toy shown in FIG. 19 is formed by die forming.

FIG. 24 is a section view to show another embodiment of die cross sections of the upper die and the lower die when the block toy shown in FIG. 19 is formed by die forming.

FIG. 25 is a section view to show an embodiment of die cross sections of an upper die and a lower die in a case where the projecting portions of a side face portion in an embodiment of the block toy according to the present invention are formed in the shape of a prism having an upper portion of a cross section shaped like a nearly circular arc projecting upward and in the shape of a prism having a lower portion of a cross section shaped like a nearly circular arc projecting downward.

FIG. 26 is a section view to show an embodiment of die cross sections of an upper die and a lower die in a case where a projecting portion of a side face portion in an embodiment of the block toy according to the present invention is formed in a cube.

FIG. 27 is a section view to show an embodiment of die cross sections of an upper die and a lower die when a projecting portion of a side face portion in an embodiment of the block toy according to the present invention is formed in the shape of a triangular prism.

FIG. 28 is a section view to show an embodiment of die cross sections of an upper die and a lower die when a projecting portion of a side face portion in an embodiment of the block toy according to the present invention is formed in the shape of a pentagonal prism.

FIG. 29 is a section view to show an embodiment of die cross sections of an upper die and a lower die when a projecting portion of a side face portion in an embodiment of the block toy according to the present invention is formed in the shape of a hexagonal prism.

FIG. 30 is a section view to show an embodiment of die cross sections of an upper die and a lower die when a projecting portion of a side face portion in an embodiment of the block toy according to the present invention is formed in the shape of an octagonal prism.

### DETAILED DESCRIPTION

The following is a description of the reference numbers used in the drawings:

10 block toy

15 projecting portion

16 projecting portion

17 recessed portion

18 projecting portion

19 projecting portion

20 block toy

21 recessed portion

22 recessed portion

25 projecting portion

25a projecting portion

25b projecting portion

26 projecting portion

26a projecting portion

26b projecting portion

27 recessed portion

28 recessed portion

29 projecting portion

30 block toy construction body

31 projecting portion

32 projecting portion

33 projecting portion

35 recessed portion

36 recessed portion

37 projecting portion

38 projecting portion

39 recessed portion

41 block toy construction body

42 block toy construction body

44 projecting portion

45 recessed portion

50 block toy

51 block toy construction body

51A reverse face side

52 block toy construction body

52a upper face side

53 projecting portion

54 recessed portion

55 projecting portion

56 recessed portion

57 projecting portion

58 recessed portion

59 recessed portion

60 projecting portion

61 projecting portion

62 recessed portion

63 projecting portion

64 projecting portion

70 block toy

71 block toy construction body

71a upper face side

72 block toy construction body

72 reverse face side

73 recessed portion

74 projecting portion

75 projecting portion

76 recessed portion

77 projecting portion

78 projecting portion

79 recessed portion

80 projecting portion

81 recessed portion

82 projecting portion

83 recessed portion

84 recessed portion

85 recessed portion

86 recessed portion

87 projecting portion

89 hollow portion

89b through hole

90 block toy

91 projecting portion shaped like a circular cylinder

92 projecting portion

93 block toy

94 block toy

95 projecting portion

95a projecting portion

95b projecting portion

96 upper die

97 lower die

98 lower portion

99 portion, by which a lower portion of an upper projecting portion is formed, of a lower die

100 portion, by which an upper inside portion of a lower projecting portion is formed, of an upper die

101 block toy

A side face (side opposite face)

B side face (side opposite face)

C side face (side opposite face)

D side face (side opposite face)

E upper face

F lower face

P bonding line

PI bonding line

PI bonding line

Hereinafter, a block toy according to one embodiment of the present invention wherein each of projecting portions on upper and lower face portions is formed in the shape of a circular cylinder and where projecting portions on the two pairs of side opposed faces are formed in the shape of a prism having an upper portion of a cross section shaped like a nearly circular arc projecting upward and in the shape of a prism having a lower portion of a cross section shaped like a nearly circular arc projecting downward will be described in detail on the basis of embodiments shown in the accompanying drawing.

The block toy according to this embodiment is a block toy that is formed of a hexahedron made of synthetic resin and that is formed so as to have other block toys engaged therewith and joined thereto in succession, wherein each face portion has plural projecting portions and plural recessed portions, and wherein the recessed portions are formed in portions adjacent in an upward direction, in a downward direction, and in a left and right direction to the projecting portions, and wherein the recessed portions are formed in size capable of receiving the projecting portions, and wherein the block toy is formed by die forming.

Hereinafter, the block toy will be described individually on the basis of the mode of embodiment.

1. Basic shape (block toy in which projecting portions are formed in two steps in the up and down direction on each of side opposite faces)

A basic shape is a mode in which projecting portions are formed in two steps in an up and down direction on each of side opposite faces).

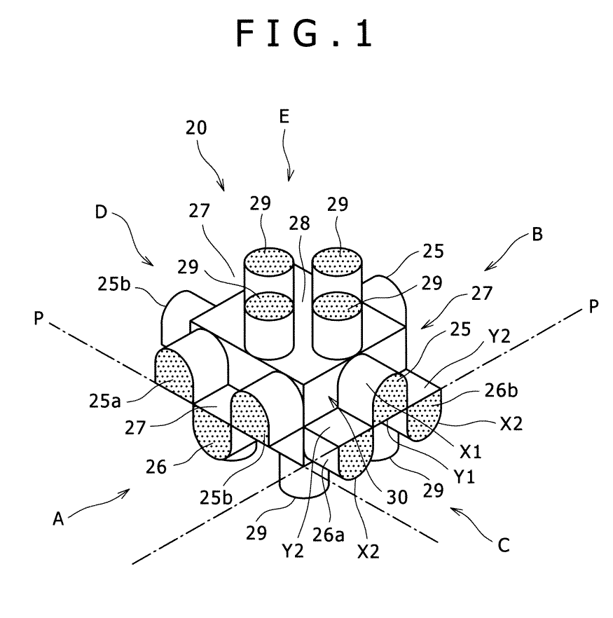

As shown in FIG. 1, a block toy 20 according to this embodiment has projecting portions formed in two steps on each of two pairs of side opposite faces A, B and C, D that construct a hexahedron and hence has three projecting portions 25a, 25b, 26, and 25, 26a, 26b formed on each face as a whole and is constructed so as to be produced by die forming by the use of an upper die and a lower die in such a way that the upper die and the lower die can be separated from each other between the projecting portions 25 of an upper step and the projecting portions 26 of a lower step.

On the side face A, the projecting portions 25, 26 of the upper and lower two steps have a pair of upper projecting portions 25a, 25b, which are formed opposite to a side face direction via a recessed portion 27, and a lower projecting portion 26 formed adjacently on a lower side in the up and down direction to the recessed portion.

Here, the projecting portions 25, 25a, 25b positioned upward of the side face are formed respectively in the shape of a prism having an upper portion X1 of a cross section shaped like a nearly circular arc projecting upward and a lower portion Y1 formed of a flat face portion, whereas the projecting portions 26, 26a, 26b positioned downward of the side face are formed respectively in the shape of a prism having a lower portion X2 of a cross section shaped like a nearly circular arc projecting downward and an upper portion Y2 formed of a flat face portion.

On a side face B opposite to the side face A, the arrangement of the projecting portions is opposite in phase to the arrangement of the recessed portions, that is, the upper projecting portion 25 is arranged at the position of the recessed portion 27, and the recessed portions 27 are arranged just below the upper projecting portions 25, and one pair of lower projecting portions 26a, 26b are arranged in one pair in the side face direction of the recessed portion 27.

Moreover, similarly, on a side face C between the side face A and the side face B, the projecting portions and the recessed portions are arranged in the same construction arrangement as on the side face B. That is, the recessed portion 27 is arranged just below the upper projecting portion 25, and one pair of lower projecting portions 26a, 26b are arranged in one pair in the side face direction of the recessed portion 27.

Further, on a side face D opposite to the side face C, an arrangement construction is the same as in the case of the side face A, that is, the projecting portions and the recessed portions are arranged opposite in phase to the side face C. Thus, the projecting portions and the recessed portions are arranged in the same construction as the side face A.

In other words, the side face D has one pair of upper projecting portions 25a, 25b, which are formed opposite to the side face direction via the recessed portion 27, and the lower projecting portion 26 which is formed adjacently on the lower side in the up and down direction to the recessed portion 27.

Moreover, each of projecting portions 29 formed on opposite faces in the up and down direction is formed in the shape of a circular cylinder, and just as with the side face portions, the projecting portions 29 and recessed portions 28 on the opposite faces in the up and down direction are arranged opposite in phase to each other.

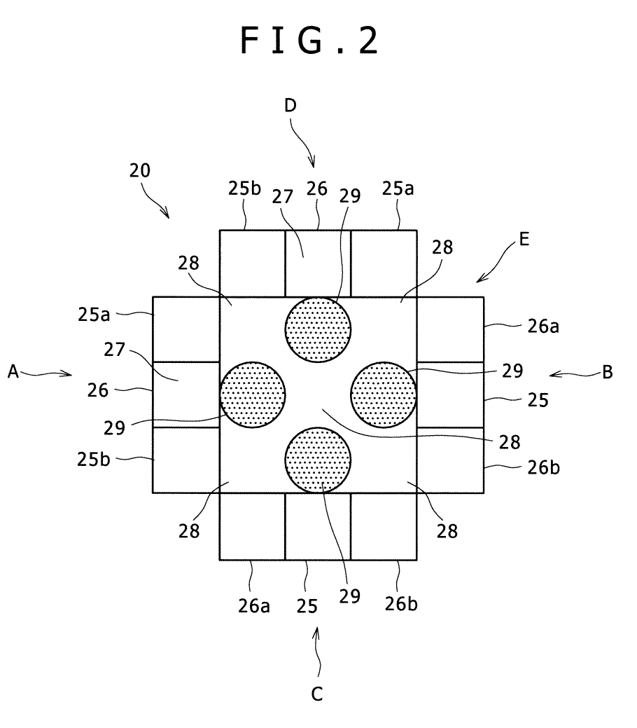

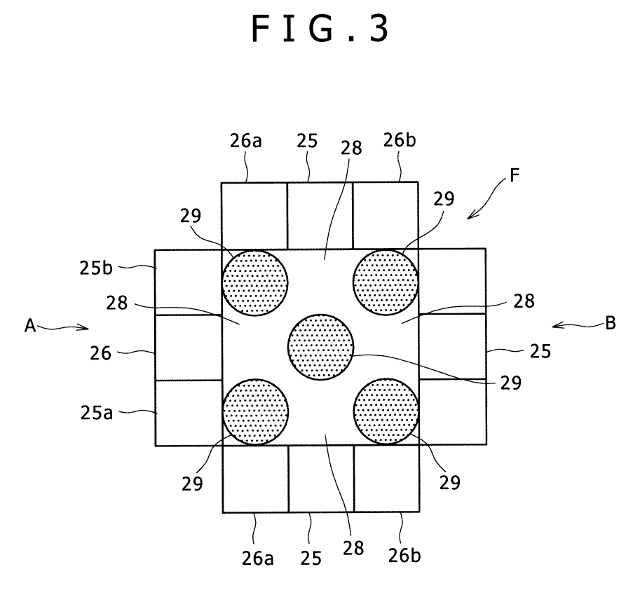

That is, as shown in FIG. 1 to FIG. 3, on an upper face E, four projecting portions 29 are formed so as to surround the periphery of the recessed portion 28, which is formed in the center, at four corners.

Moreover, on a lower face F, the projecting portions and the recessing portions are arranged opposite in phase to the upper face E, and five projecting portions 29 are formed at the positions of five recessed portions 28 on the upper face E, and four recessed portions 28 are formed at the positions of four projecting portions 29.

In the block toy 20 according to this embodiment, the respective projecting portions 25, 26, 29 are formed in a projecting manner by die forming from a main body 30 forming the core of the block toy 20, and the respective recessed portions 27, 28 are formed between the respective projecting portions 25, 26, 29. Of the respective projecting portions, each of the projecting portions 29 arranged on the upper face E and the lower face F is formed in the shape of a circular cylinder, and of the projecting portions arranged on the side faces A to D, each of the projecting portions 25, 25a, 25b positioned upward is formed in the shape of a prism having the upper portion X1 of a cross section shaped like a nearly circular arc projecting upward and a lower portion Y1 formed of a flat portion, whereas the projecting portions 26, 26a, 26b positioned downward are formed of the projecting portion 26, 26a, 26b each of which is formed in the shape of a prism having a lower portion X2 of a cross section shaped like a nearly circular arc projecting downward and an upper portion Y2 formed of a flat portion.

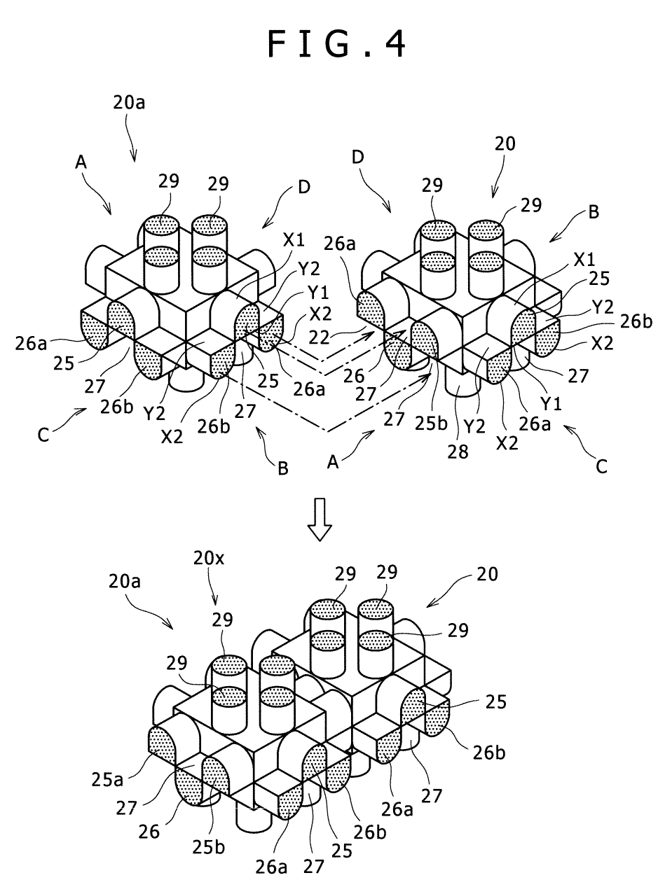

As shown in FIG. 4, when a certain block toy 20 has the side face B of another block toy 20a joined to a side face A thereof, the another block toy 20a being of the same construction as the block toy 20 according to this embodiment, as described above, because the projecting portions 25, 26a, 26b and the recessed portions 27, 28 are formed in the same dimensions in length and height and the projecting portions 25, 26 and the recessed portions 27 are arranged opposite in phase to each other on the faces opposite to each other, the upper projecting portions 25 of the block toy 20a are fitted in the recessed portions 27 of the block toy 20, whereas because the projecting portions 26a, 26b are arranged in space portions 21, 22 formed below the upper projecting portion 25a, 25b on the block toy 20 side, the two block toys 20, 20a are joined to each other on the side face A of the block toy 20 and on the side face B of the block toy 20a.

Moreover, in this case, as described above, each of the projecting portions 25, 25a, 25b has the upper portion X1 of a cross section shaped like a nearly circular arc projecting upward and the lower portion Y1 formed of a flat portion, and each of the projecting portions 26, 26a, 26b has the lower portion X2 of a cross section shaped like a nearly circular arc projecting downward and the upper portion Y2 formed of a flat portion. Thus, when a certain block toy has other block toy joined thereto, the block toy is put into line contact with the projecting portions of the other block toy at the portion of the cross section shaped like a nearly circular arc, so that frictional resistance caused when these block toys are joined to each other is made smaller and hence the projecting portions 25, 26 can be smoothly engaged with the recessed portion 27.

Furthermore, when the block toy is joined to the other block toy in the up and down direction, all of the projecting portions are put into line contact along an axial direction with each other, so that the block toys can more smoothly joined to each other.

Thus, as shown in FIG. 4, when the same block toys 20a, for example, are joined to the respective faces of the block toy 20 in this manner, a block toy junction body 20x formed by joining the block toys to each other in succession can be formed.

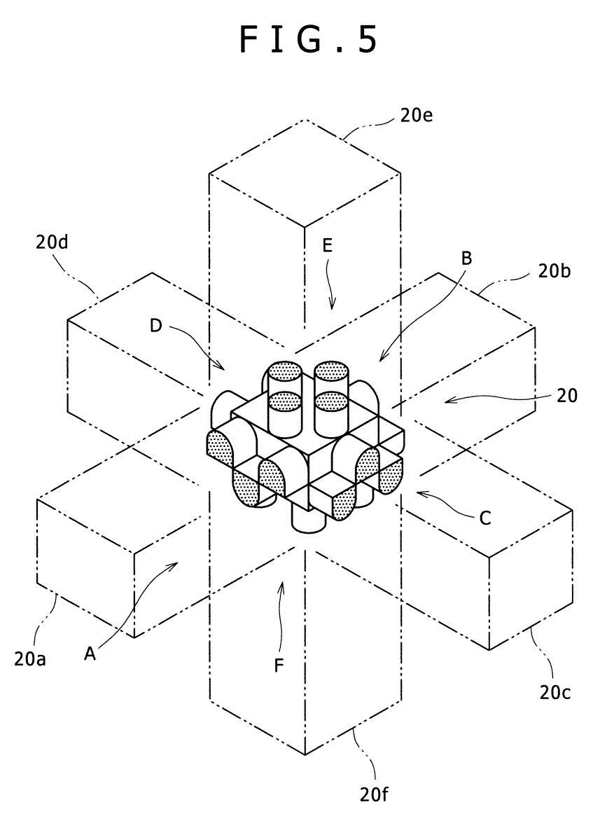

Thus, when other block toys 20a, 20b, 20c, 20d, 20e, and 20f are connected to the constituent faces A, B, C, D, E, and F of the block toy 20 in this manner, as shown in FIG. 5, the other same block toys 20a, 20b, 20c, 20d, 20e, and 20f can be engaged with and connected to the six faces in succession, thereby being joined to each other as appropriate. Thus, it is possible to form a model of various shapes.

When the block toy 20 like this is produced, the block toy can be produced by upper and lower dies.

As described above, in the block toy 20 according to this embodiment, the upper projecting portions 25, 25a, 25b and the lower projecting portions 26, 26a, 26b can be produced by die forming by the use of an upper die and a lower die in such a way that the upper die and the lower die are separated from each other between the upper projecting portions 25, 25a, 25b and the lower projecting portions 26, 26a, 26b.

In other words, the upper die forms portions from an upper end portion to the upper projecting portions 25, 25a, 25b of the block toy 20 shown in FIG. 1, whereas the lower die forms portions from a lower end portion to the lower projecting portions 26, 26a, 26b, and the upper die and the lower die are separated in the up and down direction at a parting line P, whereby the block toy 20 is formed by die forming.

In this case, the block toy 20 according to this embodiment has many projecting portions 25, 26 and recessed portions 27, 21, 22, and 28. However, all of the projecting portions 25, 26 and the recessed portions 27, 21, 22, and 28 are put into contact with the inside surfaces of the upper die and the lower die in the up and down direction and have no portion causing an interference in the up and down direction when the dies are stripped in the up and down direction, so that the block toy can be produced by one die-forming process by the use of the upper die and the lower die.

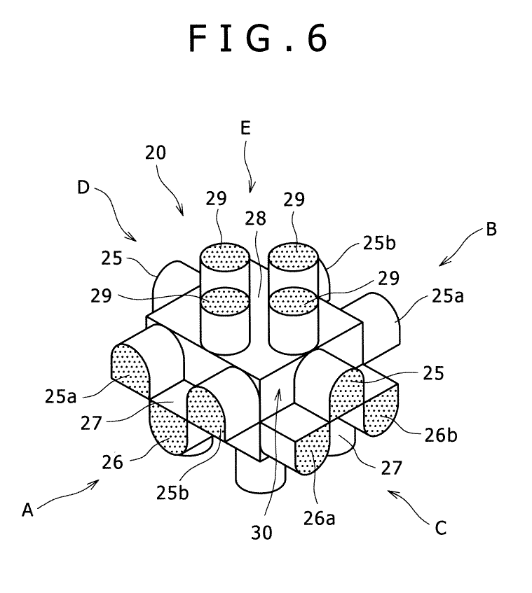

In this regard, as shown in FIG. 6, in the block toy 20, the projecting portions and the recessed portions can be formed in the same phase on the side faces A and B and on the side faces C and D.

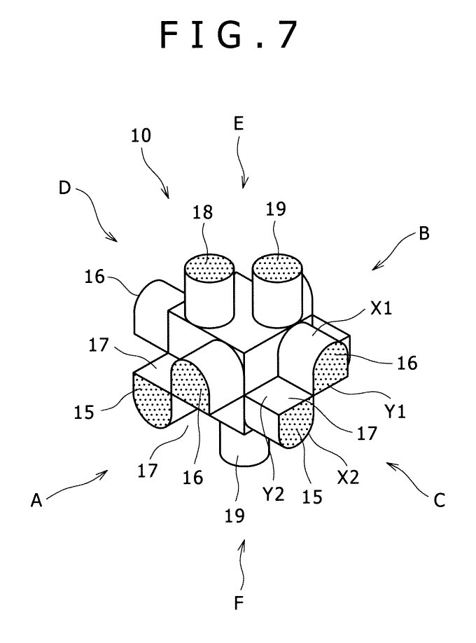

Moreover, FIG. 7 is another embodiment of the basic shape of the block toy according to the present invention.

A block toy 10 according to this embodiment has upper and lower two steps on two pairs of side opposite faces A, B and C and D, respectively, and has two projecting portions 15, 16 formed on each of the faces A, B, C, and 0 and has two projecting portions 18, 19 formed on each of the upper and lower faces E, F. The block toy 10 is constructed so as to be produced by die forming in such a way that: for example, an upper die forms the upper projecting portions 16; for example, a lower die forms the lower projecting portions 15; and the upper die and the lower die are separated from each other between the upper projecting portions 16 and the lower projecting portions 15.

In the block toy 10 according to this embodiment, of the above-mentioned projections, each of the projecting portion 15 is formed in the shape of a prism having an upper portion Xl of a cross section shaped like a nearly circular arc projecting upward and a lower portion Y1 formed of a flat portion, and each of the projecting portions 16 positioned downward is formed in the shape of a prism having a lower portion X2 of a cross section shaped like a nearly circular arc projecting downward and an upper portion Y2 formed of a flat portion. These projecting portions 15, 16 are formed in the same as the projecting portions 25, 26, 29 of the block toy 20 of the above-mentioned embodiment, and as in the case of the above-mentioned embodiment, the projecting portions 15, 16, 18, and 19 are arranged on a diagonal line each other and recessed portions 17 are formed between the projecting portions 15 and the projecting portions 16.

As in the case of the above-mentioned embodiment, on the side opposite faces A, B, C, and D and the upper face E and the lower face F, the projecting portion 15 and the recessed portion 17 are formed opposite in phase to each other on the respective opposite faces.

Thus, in the block toy 10 according to this embodiment, the block toys can be engaged with each other and, for example, by joining the block toy 10 to the block toy 20 according to the above-mentioned embodiment, it is possible to form a constituent element of a shape constructed by the block toys.

In this regard, as for the side faces A, B, C, and D, just as with the above-mentioned block toy 20 shown in FIG. 6, the projecting portions and the recessed portions can be formed also in the same phase on the side faces A and B, and on the side faces C and D, respectively.

2. Block toy having projecting portions of three steps in the up and down direction on the side opposite faces.

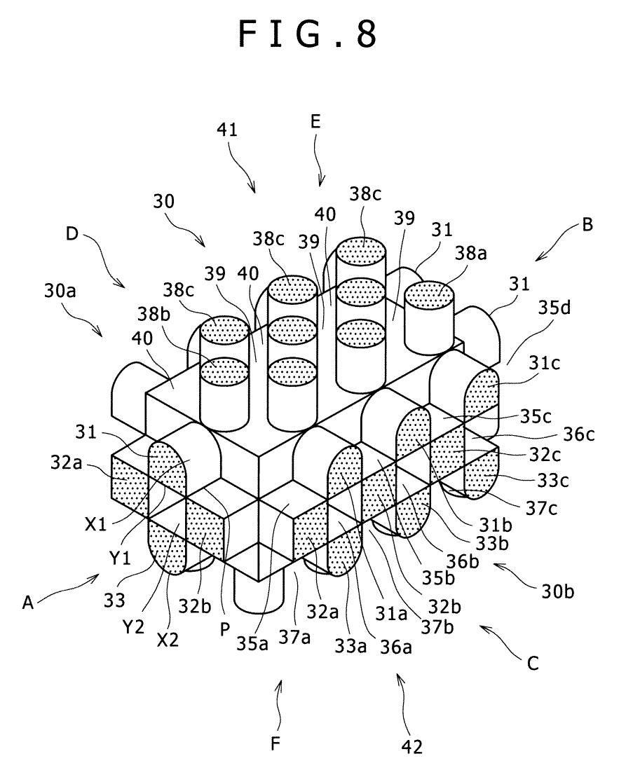

As shown in FIG. 8, a block toy 30 according to this embodiment relates to a block toy having the projecting portions of three steps in the up and down direction.

That is, the block toy 30 according to this embodiment is a block toy having the projecting portion 31, 32, and 33 of three steps in the up and down direction on two pairs of side opposite faces and is formed by joining two block toy construction bodies 41, 42 produced by die forming using an upper die and a lower die.

In the block toy 30 according to this embodiment, of the above-mentioned two block toy construction bodies 41, 42, one block toy construction body 42 has two pairs of side opposite faces A, Band C, D having the projecting portions 32, 33 of two steps, and the other block toy construction body 41 has two pairs of side opposite faces A, B and C, D having the projecting portions 31 of one step.

The block toy 30 according to this embodiment is formed in a rectangular prism as a whole and has a total of four projecting portions formed on the side opposite face A corresponding to an end face in a longitudinal direction and has a total of five projecting portions formed on the side opposite face B opposite to the side opposite face A in the longitudinal direction.

On the side opposite face A, the projecting portions of the three steps in the up and down direction include: a projecting portion 31 formed in the center of an upper step; projecting portions 32a, 32b formed in the left and right direction via a recessed portion 36 formed downward of the projecting portion 31 in a middle step; and a projecting portion 33 formed downward of the recessed portion 36 in the center of a lower step.

On the side opposite face B opposite to the side opposite face A, the arrangement of the projecting portions and the recessed portions is opposite in phase to the arrangement of the projecting portions and the recessed portions on the side opposite face A.

In other words, the recessed portion is formed at a position corresponding in the longitudinal direction to the projecting portion 31 of the upper step on the side opposite face A, and the projecting portions are formed respectively on both sides in the left and right direction of the recessed portion, and the projecting portion is formed at a portion corresponding to the recessed portion 36, and the recessed portions are formed respectively at portions corresponding to the projecting portions 32a, 32b, and the recessed portion is formed at a portion corresponding to the projecting portions 33, and the projecting portions are formed respectively on both sides in the left and right direction of the recessed portion.

In this regard, as for the side opposite face B, because the side opposite face B cannot be visually recognized in this drawing, the side opposite face B is not shown in the drawing.

Moreover, on the side faces C and D of the side faces in a width direction, nine projecting portions and nine recessed portions are formed, respectively. On the side face C, the projecting portions 31, 32, and 33 are formed in upper and lower three steps, and three projecting portions are arranged for each of the projecting portions 31, 32, and 33. Here, the shapes of the projecting portions 31 to 33 are the same as those in the construction of the side face A.

In other words, the projecting portions 31a, 31b, and 31c of the upper step are formed adjacently to the recessed portions 35a, 35b, and 35c, respectively. The projecting portions 32a, 32b, and 32c of the middle step are arranged downward of the recessed portions 35a, 35b, and 35c, respectively. The projecting portions 32a, 32b, and 32c of the middle step are formed adjacently to the recessed portions 36a, 36b, and 36c, respectively.

Moreover, the projecting portions 33a, 33b, and 33c of the lower step are arranged downward of the recessed portions 36a, 36b, and 36c, respectively. Thus, on the side face D opposite in the width direction to the side face C, the projecting portions and the recessed portions are formed at positions diametrical opposite to the arrangement of the projecting portions 31, 32, and 33 and the recessed portions 35, 36 on the side face C.

Further, on the upper face E, similarly, nine projecting portions 38 are formed. These projecting portions 38 are formed in three rows of three each along the width direction of the block toy 30.

The projecting portions 38a of a first row in the width direction and the projecting portions 38c of a third row are arranged at the same positions in the longitudinal direction as the projecting portions 31a, 31b, and 31c of the upper step on the side face C. The recessed portions 39 are formed adjacently to the projecting portions 38a, 38c between the first row and the third row, and the recessed potions 40 of a second row are arranged adjacently in the longitudinal direction to the recessed portions 39.

Moreover, on the lower face F, the projecting portions and the recessed portions are arranged opposite in phase to the arrangement of the projecting portions 38 and the recessed portions 39 on the upper face E. Here, because the lower face F cannot be visually recognized in this drawing, the lower face F is not shown in the drawing.

As in the case of the block toy 20 according to the above-mentioned embodiment, of the respective projecting portions, each of the projecting portions 38 arranged on the upper face and the lower face is formed in the shape of a circular cylinder, and each of the projecting portions 31 arranged in the upper steps of the side faces A to D is formed in the shape of a prism having the upper portion Xl of a cross section shaped like a nearly circular arc projecting upward and a lower portion Y1 formed of a flat portion, and each of the projecting portions 33 arranged in the lower step is formed in the shape of a prism having a lower portion X2 of a cross section shaped like a nearly circular arc projecting downward and an upper portion Y2 formed of a flat portion, and each of the projecting portions 32 arranged in the middle step is formed of a cube. The respective projecting portions 31, 32, 33, and 38 and the respective recessed portions 34, 35, 36, and 39 are formed in the same dimensions as those of the block toys 20, 10 according to the above-mentioned embodiment.

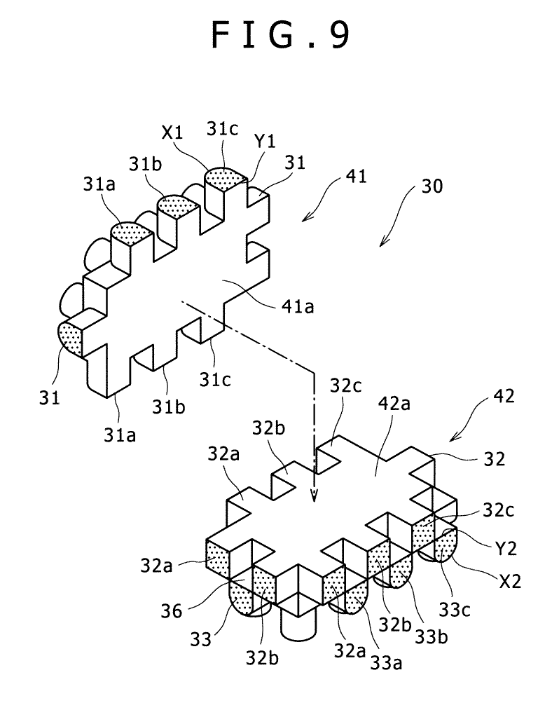

The block toy 30 constructed in this manner, as shown in FIG. 9, is produced by bonding a block toy construction body 41 to a block toy construction body 42, that is, by bonding the reverse face side 41a of the block toy construction body 41 to the upper face side 42a of the block toy construction body 42 as appropriate with an adhesive. As shown in FIG. 8, the bonding line P of the block toy construction bodies 41, 42 is formed between the upper step and the middle step on the side opposite faces.

The block toy construction body 41 has the projecting portions 31 of one step on the side opposite face in the longitudinal direction, whereas block toy construction body 42 has the projecting portions 32, 33 of two steps, three projecting portions 32 being formed on one step, three projecting portions 33 being formed on another step.

Thus, in the block toy 30 according to this embodiment, the projecting portions and recessed portions of three steps in the up and down direction are formed in a staggered manner along the longitudinal direction on the side opposite faces, so that it is impossible to strip the upper die and the lower die in the up and down direction like the block toys 10, 20 according to the above-mentioned embodiment.

However, as shown in FIG. 9, in the case of the block toy construction body 41 and the block toy construction body 42, as in the case of the block toys 10, 20 according to the above-mentioned embodiment, the block toy construction body 41 and the block toy construction body 42 can be produced by one die-stripping process of the upper die and the lower die.

Thus, by bonding the block toy construction body 41 to the block toy construction body 42 in the manner described above, it is possible to produce the block toy 30 that has the projecting portions and the recessed portions of three steps in the up and down direction on the side opposite faces formed at staggered positions and that hence cannot be produced by die forming.

In the block toy 30 constructed in this manner, as in the case of the block toy 20, the block toys 30 can be joined to each other by engaging the projecting portions with the 42 recessed portions, and further the block toy 30 can be joined also to the block toys 20, 10 because the dimensions of the projecting portions and the recessed portions are equal to each other between these block toy.

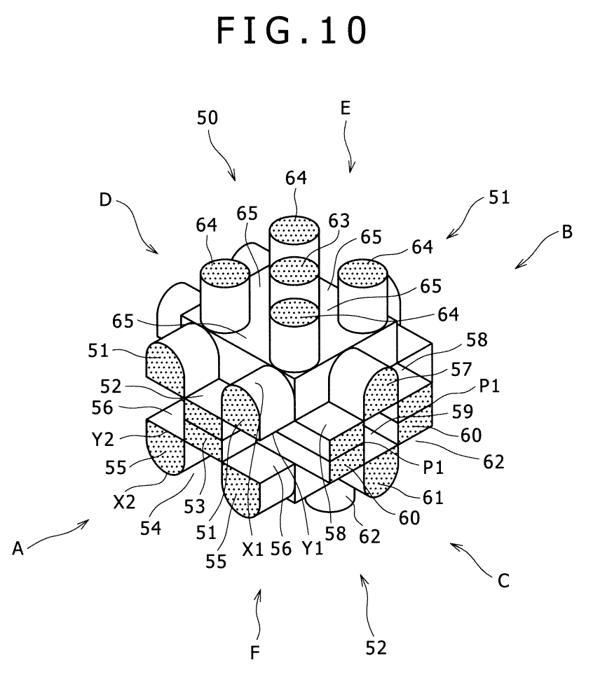

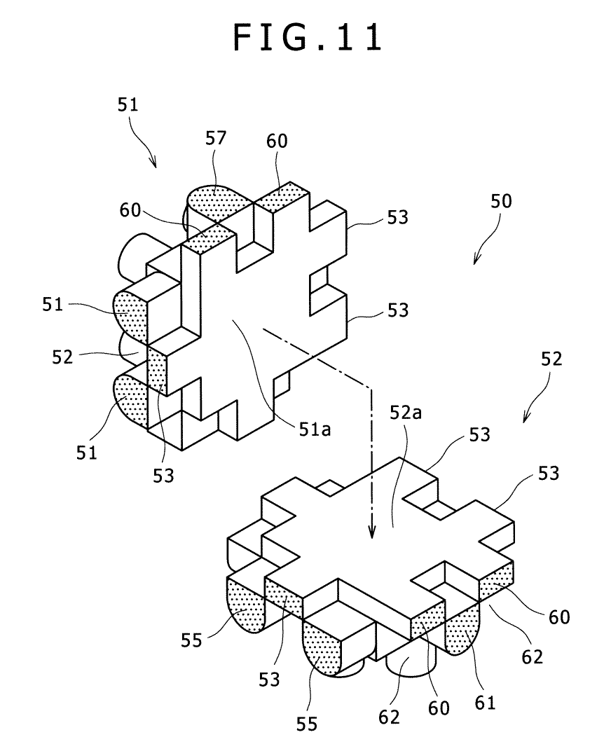

FIG. 10 and FIG. 11 show a block toy having the projecting portions of three steps in the up and down direction on the side opposite faces, as in the case of the block toy 30 shown in FIG. 8 and FIG. 9. However, a block toy 50 according to this embodiment is different from the block toy 30 in that the block toy 50 is formed of two block toy construction bodies 51, 52 joined to each other in the up and down direction at a portion separated into two blocks in the up and down direction in the projecting portion of the middle step.

In the block toy 50 according to this embodiment, on two pairs of side opposite faces A, B and C, D constructing a hexahedron, the projecting portions are formed in upper and lower three steps, and four projecting portions or five projecting portions are formed on each of the opposite faces.

In other words, as shown in FIG. 10, on the side face A, two projecting portion 51, 51 of the upper step are formed and a recessed portion 52 is formed between these projecting portions 51, 51. A projecting portion 53 of the middle step is formed downward of the recessed portion 52, and recessed portions 56, 56 are formed on both sides of the projecting portion 53 of this middle step, and a recessed portion 54 is formed downward, and projecting portions 55, 55 are formed on both sides in the width direction of the recessed portion 54.

On the side face B opposite to the side face A, the projecting portions and the recessed portions are formed in the opposite phase, so that the projecting portions are formed at the positions of the recessed portions 52, 54, and 56, whereas the recessed portions are formed at the positions of the projecting portions 51, 53, and 55. In this regard, because the side face B cannot be visually recognized, the side face B is not shown in the drawing.

Similarly, on the side face C, a projection 57 of the upper step is formed and recessed portions 58, 58 are formed on both side of this projecting portion 57. A recessed portion 59 is formed downward of the projecting portion 57 and projecting portions 60, 60 of the middle step are formed on both sides of this recessed portion 59.

Moreover, a projecting portion 61 is formed downward of the recessed portion 59, and recessed portions 62, 62 are formed on both sides of this projecting portion 61.

Further, on the side face D opposite to the side face C, just as with the above-mentioned circumstances, the above-mentioned projecting portions and recessed portions are formed in the opposite phase, respectively, so that the projecting portions are formed at positions opposite to the recessed portions 58, 59, 62, and the recessed portions are formed at positions opposite to the projecting portions 57, 60, 61, respectively. In this regard, because the side face D cannot be visually recognized, the side face D is not shown in the drawing.

In this regard, as for the shapes of the projecting portions 51, 53, 55, 57, 60, and 61 of the three steps in the up and down direction of the respective side faces, as in the case of the block toy 30 in FIG. 8, each of the projecting portions 51, 57 arranged in the upper step is formed in the shape of a prism having an upper portion Xl of a cross section shaped like a nearly circular arc projecting upward and a lower portion Y1 formed of a flat portion, and each of the projecting portions 55, 61 arranged in the lower step is formed in the shape of a prism having a lower portion X2 of a cross section shaped like a nearly circular arc projecting downward and an upper portion Y2 formed of a flat portion, and each of the projecting portions 53, 60 of the middle step is formed in a cube.

Still further, on the opposite faces E, F in the up and down direction, similarly, the projecting portions and the recessed portions are arranged opposite in phase to each other. That is, on the upper face E, a total of five projecting portions are formed. In other words, four projecting portions 64 are formed so as to surround the four corner portions of the projecting portions 63 formed in the center, and four recessed portions 65 are formed around the respective sides of the projecting portions 63 formed at the center.

Still further, on the lower face F, the projecting portions and the recessed portions are arranged opposite in phase to the upper face E, and five recessed portions are formed at positions of five projecting portions 63, 64 on the upper face E, and four projecting portions are formed at positions of four recessed portions 65. Because the lower face F cannot be visually recognized, the lower face E is not shown in the drawing. Here, the requirements relating to the dimensions of the respective projecting portions and recessed portions are the same as those of the block toy 30 according to the embodiment shown in FIG. 8 and FIG. 9.

The block toy 50 constructed in this manner, as shown in FIG. 11, is produced by bonding a block toy construction body 51 to a block toy construction body 52, that is, by bonding the reverse face side 51a of the block toy construction body 51 to the upper face side 52a of the block toy construction body 52 as appropriate with an adhesive.

As shown in FIG. 10, the bonding line P of the respective the block toy construction bodies 51, 52 in this case is shown at a middle portion in the up and down direction of the projecting portions 60 of the middle step on the side opposite faces.

The block toy construction bodies 51, 52 are formed in the same size, which is different from the block toy construction bodies 41, 42 according to the above-mentioned embodiment, and anyone of the block toy construction bodies 51, 52 has a projecting portion of one step and a half step in the up and down direction on the side face.

Thus, in the block toy 50 according to this embodiment, the projecting portions 51, 53, 55, 57, 60, and 61 of three steps in the up and down direction are formed on the side opposite faces in a staggered manner along the longitudinal direction, so that it is impossible to strip the upper die and the lower die in the up and down direction like the block toys 10, 20 according to the above-mentioned embodiment.

However, as shown in FIG. 11, in the case of the block toy construction body 51 and the block toy construction body 52, as in the case of the block toys 10, 20 according to the above-mentioned embodiment, the block toy construction body 51 and the block toy construction body 52 can be produced by one die-stripping process of the upper die and the lower die.

Thus, by bonding the block toy construction body 51 to the block toy construction body 52 in the manner described above, it is possible to produce the block toy 50 that has the projecting portions and the recessed portions of three steps in the up and down direction at the staggered positions on the side opposite faces.

Thus, in the block toy 50 constructed in this manner, as in the case of the block toy 20 and 30, the block toys 50 can be joined to each other by engaging the projecting portions with the recessed portions, and further the block toy 50 can be joined also to the block toys 20, 10, and 30 because the dimensions of the projecting portions and the recessed portions are equal to each other between these block toys which is not able to be produced by die forming.

In this regard, also in this embodiment, as in the case of the block toy 20 shown in FIG. 6, the projecting portions and the recessed portions can be also formed in the same phase on the side faces A and B and on the side faces C and D.

3. Block toy having projecting portions of four steps in the up and down direction on the side opposite faces.

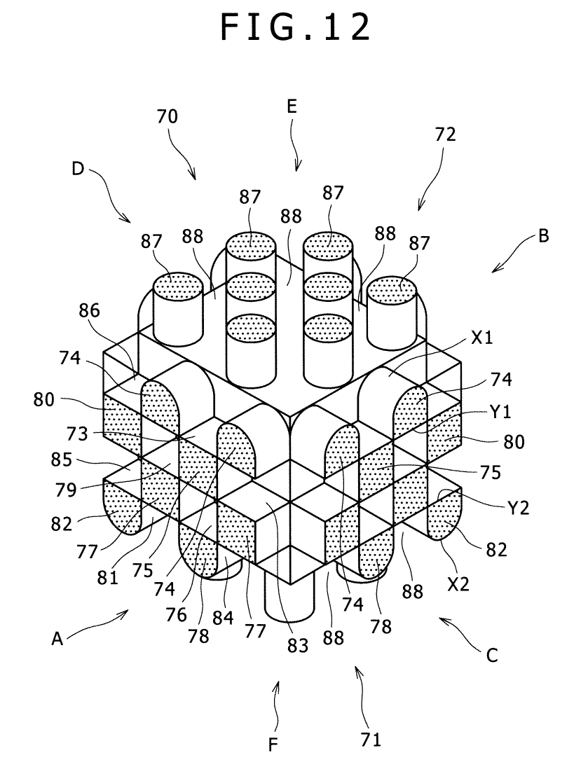

As shown in FIG. 12 and FIG. 13, a block toy having projecting portions of four steps in the up and down direction on the side opposite faces can be also produced by the use of the above-mentioned method.

That is, a block toy 70 according to this embodiment is a block toy having projecting portions of four steps in the up and down direction on two pairs of side opposite faces A, B and C, D, and is formed by bonding two block toy construction bodies 71, 72 produced by die forming using the upper die and the lower die.

Each of the two block toy construction bodies 71, 72 has one pair of side opposite faces A, B and C, D each having the projecting portions 74, 75, 77, 78, 80, and 82 of two steps.

The projecting portions of four steps in the up and down direction are formed of: projecting portions 74 of the uppermost -step each of which is formed in the shape of a prism having an upper portion Y1 having a cross section shaped like a nearly circular arc projecting upward and a lower portion Y1 having a flat portion; projecting portions 78, 82 of the lowermost step each of which is formed in the shape of a prism having a lower portion X2 having a cross section shaped like a nearly circular arc projecting downward and an upper portion Y2 having a flat portion; and the projecting portions 75, 77, 80 of the middle step each of which is formed in the shape of a cube, and includes: one pair of projecting portions 74, 74 formed opposite to the side face direction via a recessed portion 73 in the upper step; a projecting portion 75 of the upper middle step formed downward of and adjacently to the recessed portion 73; one pair of projecting portions 77, 77 of the lower middle step formed opposite to the side face direction via a recessed portion 76 formed downward of and adjacently to the projecting portion 75 of the upper middle step; and a projecting portion 78 of the lower step formed downward of and adjacently to the recessed portion 76.

In this embodiment, on the side face A of the block toy 70, a total of eight projecting portions are formed, and a recessed portion 86 is formed on the side of the projecting portion 74 of the upper step, and a recessed portion 79 is formed on the side of the projecting portion 75 of the upper middle step, and the projecting portion 80 is formed on the side of the projecting portion 75 via this recessed portion 79.

Thus, the projecting portion 75 and the projecting portion 80 are formed in the upper middle step.

Moreover, a recessed portion 85 is formed on the side of the projecting portion 77 of the lower middle step, and a recessed portion 81 is formed on the side of the projecting portion 78 of the lower step, and the projecting portion 82 is formed via this recessed portion 81, and a recessed portion 83 is formed on the side of the projecting portion 75 in the upper middle step, and a recessed portion 84 is formed on the side of the projecting portion 78.

As in the case of the block toy 50 according to the above-mentioned embodiment, on the side face B opposite to the side face A, the projecting portions and the recessed portions are formed in the opposite phase, so that the projecting portions are formed at the positions corresponding to the recessed portions 73, 76, 79, 81, 83, 84, 85, and 86, respectively, and the recessed portions are formed at the positions corresponding to the projecting portions 74, 75, 77, 78, 80, and 82, respectively. Here, because the side face B cannot be visually recognized, the side face B is not shown in the drawing.

Similarly, on the side face C, the projecting portions and the recessed portions are formed so as to be laterally symmetric about a line with respect to those on the side face A. Moreover, on the side face D opposite to the side face C, just as with the above-mentioned case, the projecting portions and the recessed portions are formed in the opposite phase to the projecting portions and the recessed portions on the side face C, which is the same as in the above-mentioned embodiment.

Moreover, also on the opposite faces E, F in the up and down direction, similarly, the projecting portions and the recessed portions are arranged in the opposite phase, and on the upper face E, a total of eight projecting portions are formed. That is, projecting portions 87 of four rows are formed along the width direction, and recessed portions 88 are formed adjacently to each other between these projecting portions 87.

Further, on the lower face F, the projecting portions and the recessed portions are arranged in the opposite phase to those on the upper face E. Because the lower face F cannot be visually recognized, the detailed illustration of the lower face F is omitted. Here, the requirements of the shapes and dimensions of the respective projecting portions and recessed portions are the same as those in the case of the block toy 30 according to the above-mentioned embodiment.

The block toy 70 constructed in this manner, as shown in FIG. 13, is produced by bonding a block toy construction body 71 to a block toy construction body 72, that is, by bonding the reverse face side 72a of the block toy construction body 72 to the upper face side 71a of the block toy construction body 71 as appropriate with an adhesive.

Thus, in the block toy 70 according to this embodiment, the projecting portions 74,75,77,78, 80, and 82 of four steps in the upper and down direction and the recessed portions 73, 76, 79, 81, 83, 84, 85, 86, and 88 of four steps in the upper and down direction are formed on the side opposite faces A, B, C, and D in a staggered manner along the longitudinal direction, so that it is impossible to form the block toy 70 by the use of the upper die and the lower die in the up and down direction like the block toys 10, 20 according to the above-mentioned embodiment.

However, as shown in FIG. 13, in the case of the block toy construction body 71 and the block toy construction body 72, as in the case of the block toys 10, 20 according to the above-mentioned embodiments, the block toy construction body 71 and the block toy construction body 72 can be produced by one die-stripping process of the upper die and lower die.

Thus, by bonding the block toy construction body 71 to the block toy construction body 72 in the manner described above, it is possible to produce the block toy 70 that has the projecting portions and the recessed portions of four steps in the up and down direction on the side opposite faces formed at staggered positions and that hence cannot be produced by die forming.

Thus, in the block toy 70 constructed in this manner, as in the case of the block toys 20, 30, and 50, the block toys 70 can be bonded to each other by engaging the projecting portions with the recessed portions, and further the block toy 70 can be joined also to the block toys 20, 10, 40, and 50, because the dimensions of the projecting portions and the recessed portions are equal to each other between these block toys.

In this regard, also in this embodiment, just as with the block toy 20 shown in FIG. 6, the projecting portions and the recessed portions can be also formed in the same phase on the side faces A and B and on the side faces C and D.

### 4. Variations.

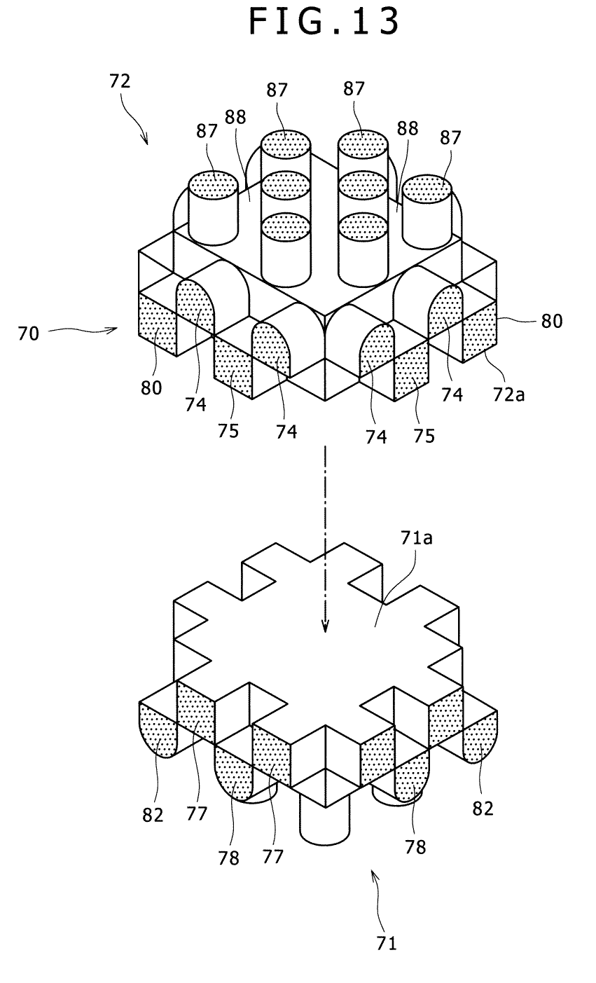

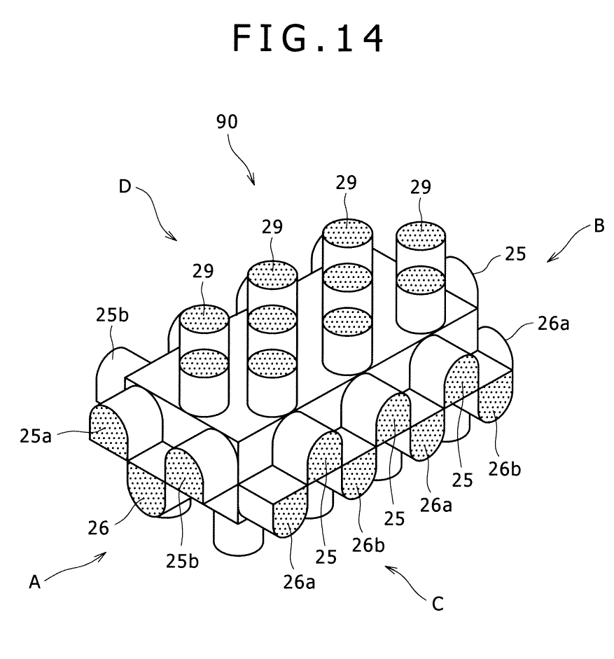

(1) In the block toy according to the first embodiment, wherein the two pairs of side opposite faces A, B, and C, D constructing the hexahedron have the projecting portions formed in the upper and lower two steps and have, as a whole, three projecting portions 25a, 25b, 26, and 25, 26a, 26b formed on each face, has been described as an example. However, even if the projecting portions are formed in upper and lower two steps, the arrangement of the projecting portions is not limited to the arrangement in the above-mentioned embodiment but, for example, like a block toy 90 shown in FIG. 14, only one pair of side faces A and B may have three projecting portions formed thereon respectively, and the other one pair of side faces C and D may have many projecting portions 25, 26a, 26b formed thereon, respectively. In the embodiment shown in FIG. 14, the one pair of side faces C and D have seven projecting portions formed thereon, respectively.

As for the number of the projecting portions and the recessed portions constructing the side faces, when the side face is constructed of the projecting portions of two steps, it is possible to respond to a change in the number by changing the dimensions of width and length of the upper die and the lower die. Thus, the projecting portions and the recessed portions can be easily formed by die forming, and hence a block toy having the projecting portions formed of upper and lower two steps of various lengths can be produced and applied to various uses.

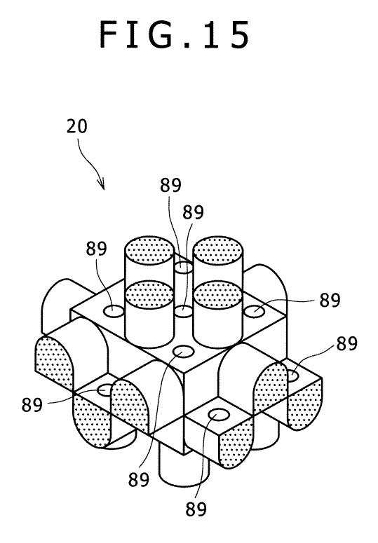

(2) Moreover, as shown in FIG. 15, when the block toy 20 and the like according to the respective embodiments are formed by die forming, circular cylindrical hollow portions 89 can be also formed in the up and down direction in the recessed portions formed on the upper face portion and the lower face portion of the block toy 20 and in the opposite faces to faces each having a cross section shaped like a nearly circular arc in the projecting portions 25, 26 formed on the two pairs of side opposite faces A, B and C, D.

When the respective projecting portions are formed in a solid state by the die forming and the dies are stripped, there are cases where an event called “shrinkage” is caused, that is, where the respective side faces are shrunk to make it difficult to form flat and smooth side faces. However, when the block toy is formed by the die forming so as to form the circular cylindrical hollow portions 89 in this manner, it is possible to prevent the event called shrinkage” and to provide a block toy that is provided with the projecting portions having flat and smooth side faces and which hence is of high external appearance quality.

Moreover, at the same time, it is possible to reduce the quantity of synthetic resin of raw material and hence to reduce production cost.

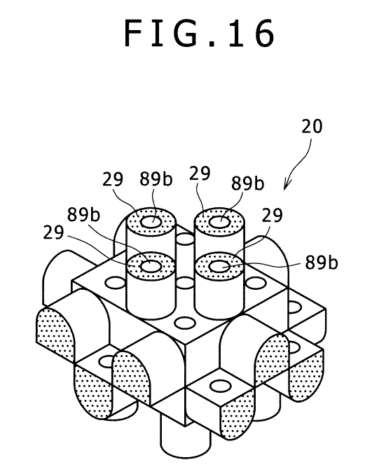

Further, as shown in FIG. 16, when the block toy 20 according to the respective embodiments is formed by die forming, through holes 89b can be also formed in the up and down direction in the projecting portions 29 formed on the upper face portion and the lower face portion.

The above-mentioned construction can increase the elasticity of the projecting portion 29. Thus, it is possible to provide a block toy that can effectively absorb a little production error, which might be caused by the die forming, and that can hence have the other block toys connected thereto in succession.

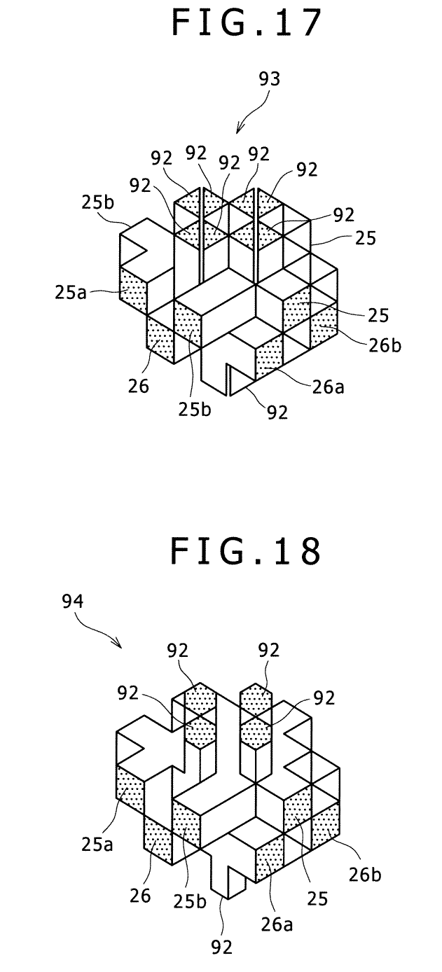

(3) Further, as shown in FIG. 17 to FIG. 20, the shapes of the projecting portions formed on the upper face and the lower face can be also changed as appropriate.

Still further, also the shapes of the projecting portions formed on the side faces can be formed not only in the shape of the circular prism but also in the shape of a polygonal prism such as a triangular prism, a rectangular prism, a cube, a pentagonal prism, a hexagonal prism, and an octagonal prism.

For example, as shown in FIG. 17, in a block toy 93 formed fundamentally in the same shape as the block toy 20 according to the first embodiment, each of projecting portions 92 formed on the upper face can be also formed in the shape of a triangular prism. Further, as shown in FIG. 18, a block toy 94 can be also produced in which projecting portions 92 each of which is shaped like a hexagonal prism are formed on the upper face and lower face by the die forming.

In this manner, the shapes of the projecting portions formed on the upper face and the lower face can be formed by the die forming by changing the shapes of the forming side faces of the upper die and the lower die as appropriate, so that a block toy having the projecting portions of various shapes formed on the upper face and the lower face can be produced.

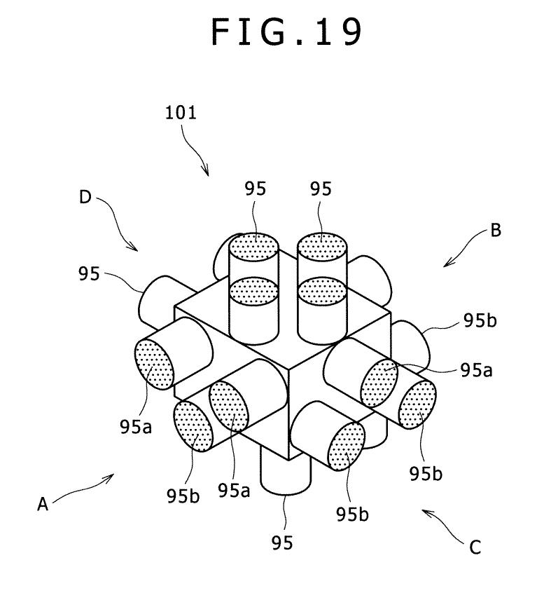

Further, as shown in FIG. 19, a block toy having projecting portions each of which is formed in the shape of a circular prism on all of six faces can be also produced by the die forming. In the block toy 101 shown in FIG. 18, the shapes of all projecting portions are constructed in the shape of a circular prism on the basis of the block toy 20 according to the first embodiment.

In the block toys 93, 94, and 101 of the embodiments shown in FIG. 17 to FIG. 20, the projecting portions 92, 93, 95 of various shapes are formed in the same dimensions as the projecting portions 18, 19, 25, 26, 29, 31, 32, 33, 38, 39, 51, 53, 55, 74, 80, 82, 87, and 88 of the block toys according to the embodiments shown in FIG. 1 to FIG. 14.

Thus, even if the block toys 10, 20, 30, 50, 70, 90, 93, 94, and 101 having anyone of shapes are selected, the block toys can be fitted in each other because the dimensions of the projecting portions of the block toys are the same. Thus, it is possible to perform the construction of a figure by a wide variety of combinations of the block toys.

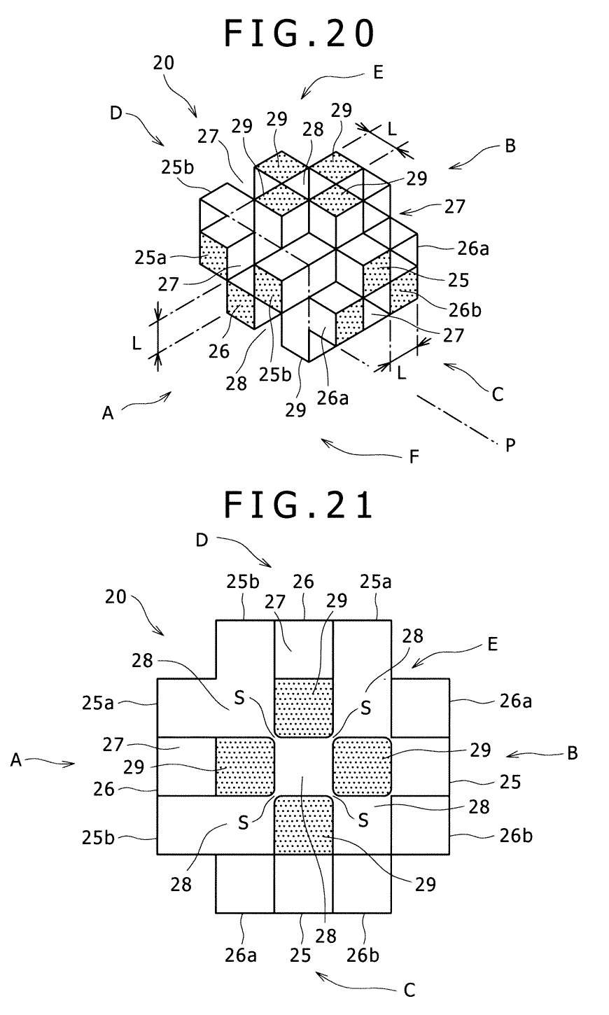

Moreover, as shown in FIG. 20, in the block toy 20 according to the first embodiment, all of the projecting portions formed on six faces can be also formed of a cube having the same dimension L.

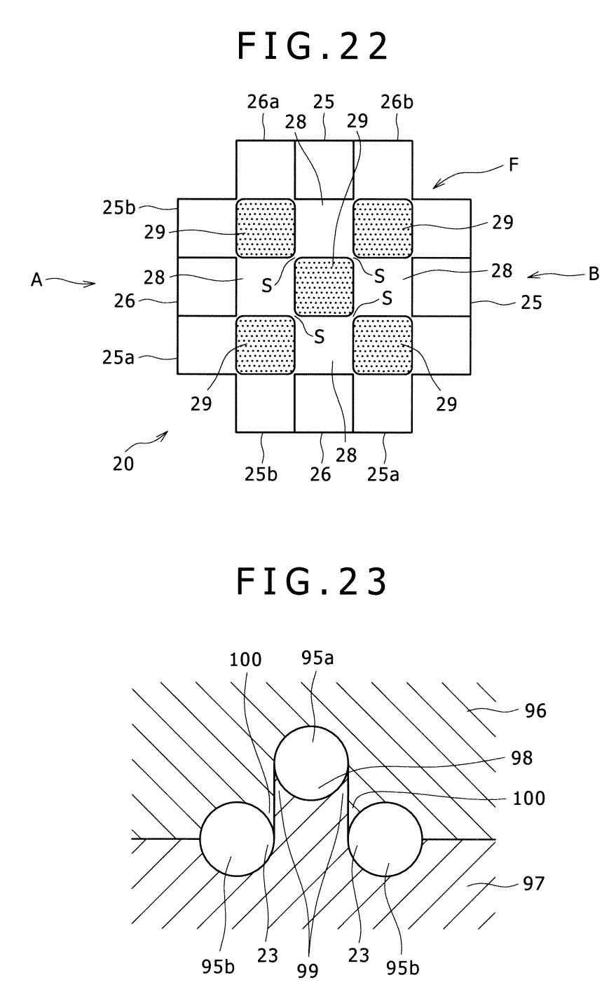

In the above-mentioned case, as shown in FIG. 21 and FIG. 22, when a small gap portion S is formed between the projecting portions 25, 26, the projecting portions 25, 26 can be smoothly engaged with the recessed portions 27.

Further, also in the respective block toys 10, 30, 50, and 70 according to the other embodiments, when all of the projecting portions are formed of cubes and the gap portions are formed between the respective projecting portions formed on the same face in the same manner described above, the same operation and effect can be provided.

Also when the block toy 101 according to this embodiment is produced, as in the case of the block toy 20, because the projecting portions 95 are formed in upper and lower steps on two pairs of side opposite faces A, B and C, D, as in the case of the block toy 20 according to the first embodiment, when the block toy 101 is produced by the die forming, the block toy 101 can be produced by one die-stripping process of the upper die and the lower die.

However, when the block toy 101 having the projecting portions 95 shaped like a cylindrical prism is produced by the die forming by the use of the upper die and the lower die, as shown in FIG. 23, for example, in the side faces C, D of the respective dies 96, 97, the respective half portions in the up and down direction of the projecting portions 95a, 95, 95b shaped like a cylindrical prism are formed by one of the respective dies 96, 97, respectively. Thus, anyone of a portion 99 for forming a lower portion 98 of an upper projecting portion 95a of the lower die 97 and a portion 100 for forming an upper inside portion 23 of a lower projecting portion 95b of the upper die 96 has a die cross section shaped like a semicircle when viewed from the side and hence has an acute die tip portion.

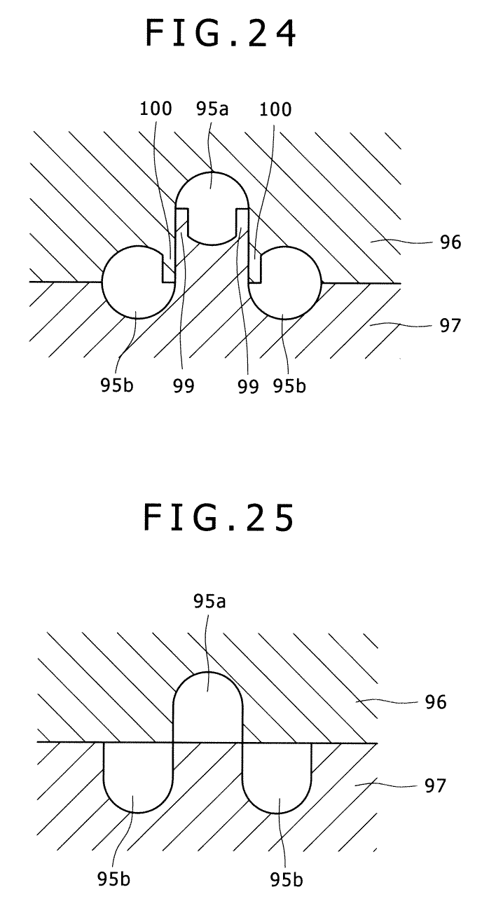

In this case, when it is considered that the upper die 96 and the lower die 97 might be damaged by the fact that both of the dies are brought into sliding contact in the up, and down direction with each other when the dies are combined with and separated from each other at the time of performing the die forming, as shown in FIG. 24, if the dies 96, 97 are made to have a specified thickness at the above-mentioned portions 99, 100 so as to hold rigidity against the sliding contact in the up and down direction caused when the dies are combined with and separated from each other, it is possible to provide the upper die 96 and the lower die 97 having the above-mentioned portions 99, 100 of the dies 96, 97 little damaged even when time passes.

In this case, the projecting portions 95a, 95b, 95b each shaped like a circular prism are not perfectly circular prisms, but the upper projecting portion 95a is formed in a shape having 60 both lower side portions cut and each of the lower projecting portions 95b, 95b is formed in a shape having an inside upper portion cut.

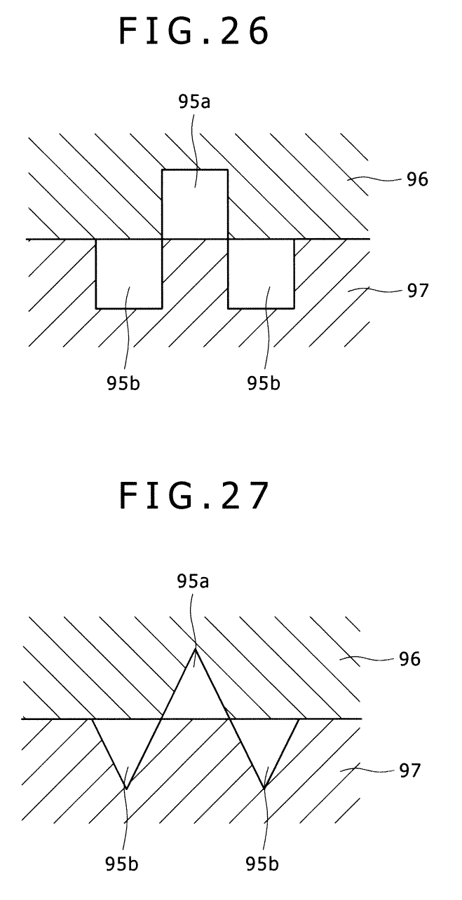

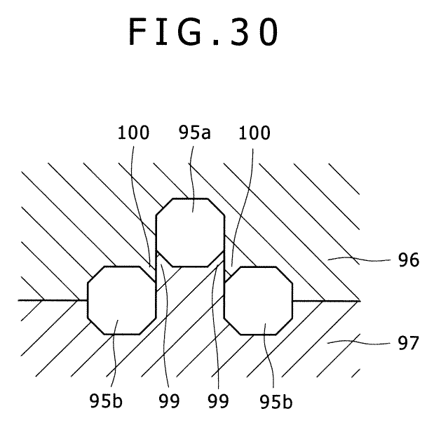

Moreover, the shapes of the upper and lower dies when the block toy 20 according to the first embodiment is produced by the die forming are shown in FIG. 25, and the shapes of the upper and lower dies when the shapes of the projecting portions formed on the side faces of the block toy 20 are a cube, a triangular prism, a pentagonal prism, a hexagonal prism, and an octagonal prism are shown in FIG. 26 to FIG. 30, respectively.

As shown in FIG. 25 to FIG. 27, when the shapes of the projecting portions formed on the side faces are that in the first embodiment and the triangular prism or the cube, the upper die 96 and the lower die 97 do not have an acute die tip portion formed thereon. Hence, the dies can be easily manufactured and are less damaged when time passes.

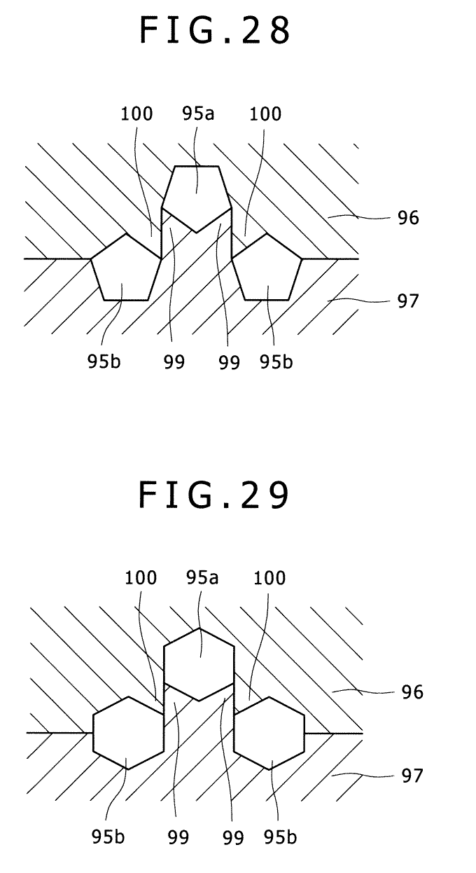

On the other hand, as shown in FIG. 28 to FIG. 30, when the shapes of the projecting portions formed on the side faces are the pentagonal prism, the hexagonal prism, and the octagonal prism, as in the case where the projecting portion is shaped like a circular cylindrical prism, one of the dies 96, 97 forms a half portion in the up and down direction of the projecting portion on the side faces C, D, respectively.

Thus, each of the portions 99 to form the lower portion 98 of the upper projecting portion 95a of the lower die 97 and the portions 100 to form the upper inside portions 23 of the lower projecting portions 95b of the upper die 96 has an acute die tip portions.

1. A block toy that is formed of a hexahedron and which can be engaged with and connected to each other,
wherein each face portion has a plurality of projecting portions and a plurality of recessed portions,
wherein the recessed portions are formed at portions adjacent in an upward direction, in a downward direction, and in a left and right direction to the projecting portions and are formed in sizes capable of receiving the projecting portions, and
wherein the block toy is formed by die forming,
wherein two pairs of side opposite faces have the projecting portions of upper and lower two steps,
wherein the projecting portion of the upper step is formed by an upper die and the projecting portion of the lower step is formed by a lower die, and
wherein the block toy is formed by separating the upper die and the lower die between the projecting portion of the upper step and the projecting portion of the lower step.

2. The block toy as claimed in claim 1,
wherein the projecting portions of the upper and lower two steps include one pair of projecting portions formed opposite to a side face direction via a recessed portion and another projecting portion formed adjacently in an up and down direction to the recessed portion.

3. The block toy as claimed in claim 1,
wherein the block toy is a block toy having projecting portions of three steps in an up and down direction formed on two pairs of side opposite faces, and wherein the block toy is formed by bonding two block toy construction bodies produced by die forming using an upper die and a lower die.

4. The block toy as claimed in claim 3,
wherein of the two block toy construction bodies, one block toy construction body has two pairs of side opposite faces having projecting portions of upper and lower two steps and another block toy construction body has two pairs of side opposite faces having projecting portions of upper and lower one step.

5. The block toy as claimed in claim 4,
wherein in one of one pair of side opposite faces, the projecting portions of three steps in the up and down direction have: a pair of projecting portions arranged respectively on both sides of two recessed portions formed along the up and down direction; and a projection portion arranged adjacently in the up and down direction to the recessed portion; and
wherein in another of the one pair of side opposite faces, the projecting portions of three steps in the up and down direction have: two projecting portions formed along the up and down direction; a recessed portion arranged adjacently in the up and down direction of the two projecting portions; and a projecting portion arranged adjacently in a left and right direction to the recessed portion.

6. The block toy as claimed in claim 3,
wherein each of the two block toy construction bodies has two pairs of side opposite faces having the projecting portion of a first step and a half portion in the up and down direction of the projecting portion of a second step.

7. The block toy as claimed in claim 6,
wherein the projecting portions of three steps in the up and down direction include: a pair of projecting portions formed opposite to a side face direction via a recessed portion in a middle step portion; and another pair of projecting portions that are formed adjacently in the up and down direction to the recessed portion and which are opposite to each other.

8. The block toy as claimed in claim 1,
wherein the block toy is a block toy having projecting portions of four steps in an up and down direction on two pairs of side opposite faces and is formed by bonding two block toy construction bodies produced by die forming using an upper die and a lower die.

9. The block toy as claimed in claim 8,
wherein each of the two block toy construction bodies has one pair of side opposite faces having projecting portions of two steps.

10. The block toy as claimed in claim 9,
wherein the projecting portions of four steps in the up and down direction include: one pair of projecting portions formed opposite to a side face direction via a depressed portion; a projecting portion formed adjacently in the up and down direction to the recessed portion; one pair of projecting portions formed opposite to the side face direction via a recessed portion formed adjacently in the up and down direction to the projecting portion; and a projecting portion formed adjacently in the up and down direction to the recessed portion.

11. A method for producing a block toy, which is a hexahedron
and has projecting portions of upper and lower two steps on side faces, by an upper die and a lower die,
wherein two pairs of side opposite faces have projecting portions of upper and lower two steps,
wherein the projecting portion of the upper step is produced by the upper die and the projecting portion of the lower step is produced by the lower die, and
wherein the block toy is produced by die forming in such a way that the upper die and the lower die are separated from each other between the projecting portion of the upper step and the projecting portion of the lower step.

12. The method for producing a block toy as claimed in claim 11,
wherein the block toy is produced so as to be engaged with and connected to each other,
wherein each face portion has a plurality of projecting portions and a plurality of recessed portions, and
wherein the recessed portions are formed at portions adjacent in an upward direction, in a downward direction, and in a left and right direction to the projecting portions and are formed in sizes capable of receiving the projecting portions.

13. The method for producing a block toy as claimed in claim 11,
wherein the block toy having the projecting portions of three or more steps in an up and down direction on side faces is produced by bonding a block toy construction body having the projecting portions of upper and lower two steps on the side faces to a block toy construction body having the projecting portions of upper and lower one step or more on the side faces.
